(19) United States
(12) Patent Application Publication
(10) Pub. No.: US 2019/0000036 A1
(43) Pub. Date: Jan. 3, 2019

(54) ROTARY APPARATUS FOR THROWING FEED

(71) Applicant: Young Jun Hong, Goyang-si (KR)

(72) Inventor: Young Jun Hong, Goyang-si (KR)

(21) Appl. No.: 15/963,165

(22) Filed: Apr. 26, 2018

(30) Foreign Application Priority Data
Jun. 29, 2017 (KR) 10-2017-0082695

(51) Int. Cl. A01K 5/02

(52) U.S. Cl. CPC A01K 5/02

(57) ABSTRACT

The rotary apparatus for throwing a feed according to the present invention includes: a pellet supply unit discharging a pellet feed from an inner space in which the pellet feeds for a pet are stored; a feed throwing unit receiving the set number of feeds from the pellet supply unit to throw the feed in the air; a rotation driving unit rotating the feed throwing unit to adjust a throwing direction of the feed; and a control unit controlling operation of the pellet supply unit, the feed throwing unit, and the rotation driving unit according to an input signal. Therefore, the pet may feel the fun and eat the feed, the feed may be regularly supplied even when the user is absent, and the quantity of exercise of the pet may be improved.

### TECHNICAL FIELD

The present invention relates to a rotary apparatus for throwing a feed, which throws a feed having the form of a pellet to a pat while rotating.

### BACKGROUND ART

Recently, there are more households that have pets for small households such as single-person households and two-person households and for the purpose of raising the emissions of children.

In order to keep such a pet healthy, continuous management is necessary. In particularly, in the case of feeding, it is necessary to feed a fixed amount of feeds at a certain time to prevent problems such as obesity due to malnutrition or overeating.

However, there are cases in which the feeds are not regularly supplied to the pet due to a long-term outing and the like. As a result, there is a drawback in that the pet eats the feeds in a hurry. Also, if a large amount of feeds is supplied at a time when going out for a long time, there is a problem that the pet suffer health problems due to ingestion of the feeds at once or altered feeds.

In order to solve such a problem, Korean Patent Publication No. 10-2016-0081468 discloses an intelligent feed supply apparatus for a pet, which automatically supplies pet's feeds by a set amount at a set time interval even when the owner of the companion animal empties the house.

However, in the case of the above-described technique according to the related art, even if the owner goes out, it is possible to feed the feeds to the pet, but the pet swallows the foods without chewing, resulting in health problems such as poor digestion. Also, there is a problem that the physical strength of the pet is lowered because the pet has less momentum due to the absence of the owner, and there is a problem that the pet is separated from the owner and thus feels psychological instability.

U.S Patent Publication No. 14-205434 according to the related art discloses an apparatus for launching a feed, which hits the feed by using a pusher after the feed is mounted on a specific position to launch the feed to be supplied.

However, the feed may be damaged while the feed is hit, and since the user directly adjusts a launching position while the user grips the apparatus for launching the feed by using a hand thereof, it is difficult to launch the feed at an adequate position, and there is a risk of launching the feed toward the pet if the user is mistaken.

U.S Patent Publication No. 14-997007 according to the related art discloses a feed supply apparatus in which pellets of feeds are pushed to be discharged from a feed storage box by using a first pusher, and the discharged feeds are hit and launched by a second pusher to launch and supply the pellet feeds.

However, when the feed is properly seated on an upper portion of the first pusher, a problem that the feed is not discharged even when the first pusher ascends frequently occurs, the feed is damaged while hitting the discharged feed by the second pusher, and there is difficult to improve a quantity of exercise of the pet through falling of the launched feed to a certain position.

### DISCLOSURE OF THE INVENTION

### Technical Problem

Also, to solve the above-described background art, an object of the present invention is to provide a rotary apparatus for throwing a feed, which regularly supplies feeds even when a user is not present to improve a quantity of exercise of a pet.

Also, an object of the prevent invention is to provide a rotary apparatus for throwing a feed, which variously adjusts a feeding position for a pet at a remote place by a user to minimize psychological instability felt due to the separation from the owner.

### Technical Solution

The rotary apparatus for throwing a feed according to the present invention includes: a pellet supply unit discharging a pellet feed from an inner space in which the pellet feeds for a pet are stored; a feed throwing unit receiving the set number of feeds from the pellet supply unit to throw the feed in the air; a rotation driving unit rotating the feed throwing unit to adjust a throwing direction of the feed; and a control unit controlling operation of the pellet supply unit, the feed throwing unit, and the rotation driving unit according to an input signal.

Preferably, the pellet supply unit may include: a body part having a fixed hole, through which the feed is discharged, in a bottom of the inner space; and a rotation plate part having one or more rotation holes that relatively rotate with respect to a bottom surface of the body part and rotating so that the pellet feed is discharged from a position at which each of the rotation holes and the fixed hole meet each other.

Preferably, the feed throwing unit may include: a throw part including a throw container coupled to a rotating throw arm to allow the pellet feed to be seated thereon; a rotation support part coupled to a rotational center of the throw arm; and an elastic driving part rotating the throw container between a seating position at which the feed is seated and a throwing position at which the feed is thrown.

Preferably, the rotation driving unit may include: a base on which the feed throwing unit is seated on an upper portion thereof; and a base driving part rotatably driving the base with respect to an axis perpendicular to a horizontal plane.

Preferably, the rotation driving unit may further include a base tilting driving part tilting the base, and the control unit controls a tilted degree of the base tilting driving part to adjust a throwing angle of the feed

Preferably, the rotary apparatus may further include: a camera unit obtaining image information of the pet; and a wired or wireless communication unit transmitting the image information to a user terminal and receiving the input signal inputted into the user terminal.

Preferably, the camera unit may be driven to rotate together with the feed throwing unit by the rotation driving unit.

Preferably, the camera unit may be connected to the control unit in a wired or wireless manner to obtain trace image information of the feed thrown at a fixed position spaced apart from the feed throwing unit.

Preferably, the control unit may further include a sight line generation part that combines sight line information for displaying a throwing direction of the feed by the feed throwing unit on a display of the user terminal with the image information, and the communication unit may transmit the image information with which the sight line information is combined to the user terminal.

Preferably, the camera unit may include a wide-angle lens.

Preferably, the input signal may include throwing information constituted by a throwing intensity and a throwing angle (θ) of the feed throwing unit and a throwing azimuth (φ) due to the rotation of the rotation driving unit, and the control unit may include: a reach position calculation part calculating a predicted reach position (B) of the feed according to the throwing information; and a moving distance calculation part calculating a predicted cumulative moving distance of the pet by cumulatively adding distances (L) between the predicted reach positions of the feeds that are sequentially thrown from the feed throwing unit.

Preferably, the throwing information may further include a height (h) from the ground on which the feed throwing unit is installed.

Preferably, the rotary apparatus may further include a display unit provided with an input unit into which the input signal is inputted, wherein the control unit may display the predicted cumulative moving distance on the display unit whenever the feeds are sequentially thrown from the feed throwing unit.

Preferably, the rotary apparatus may further include a database part storing consumed calorie information for each weight of the pets according to the moving distance, wherein the input signal may further include weight information of the pet that eat the feed, and the control unit may further include a consumed calorie calculation part calculating consumed calorie corresponding to the predicted cumulative moving distance according to the weight information inputted into the database part.

Preferably, the input signal may include throwing information constituted by a throwing angle (θ) of the feed throwing unit and a throwing azimuth (φ) due to the rotation of the rotation driving unit, and the control unit may control the feed so that the feed is thrown according to the inputted throwing information.

Preferably, the input signal may include thrown feed number and random mode selection information, and the control unit changes at least one of a throwing intensity, a throwing angle (θ), and a throwing azimuth (φ) of the feed throwing unit according to the inputted random mode selection information to control the number of feeds so that the feeds are thrown to correspond to the inputted number of feed to be thrown.

### Advantageous Effects

In the rotary apparatus for throwing the feed according to the present invention, since the pellet feed is thrown to be supplied, the pet may feel the fun and eat the feed, the feed may be regularly supplied even when the user is absent, and the quantity of exercise of the pet may be improved.

Also, according to the present invention, the user may variously adjust the feeding position for the pet at the remote place to minimize the psychological instability felt due to the separation from the owner.

Also, according to the present invention, the feed may be supplied in the form of the pellet so that the pet chews the feed to help the digestion of the pet.

Also, according to the present invention, the base driving part and the base tilting driving part may be provided to adjust the throwing direction of the feed and the throwing angle of the feed.

Also, according to the present invention, the camera unit and the communication unit may be provided to confirm that the pet eats the feed through the user terminal.

Also, according to the present invention, the sight line generation part may be provided to display the throwing direction of the feed on the user terminal.

Also, according to the present invention, the moving distance calculation part may be provided to calculate the throwing intensity of the feed, the throwing angle, and the moving distance of the pet according to the throwing azimuth.

Also, according to the present invention, the database part and consumed calorie calculation part may be provided to calculate the consumed calorie corresponding to the moving distance of the pet.

Also, according to the present invention, the feed may be thrown according to the inputted throw information.

Also, according to the present invention, at least one of the throwing intensity of the feed, the throwing angle of the feed, and the throwing azimuth may be changed according to the random mode selection information to throw the feed.

### BRIEF DESCRIPTION OF THE DRAWINGS

FIG. 1 is a perspective view of a feed supply unit according to the present invention.

FIG. 2 is a front view of the feed supply unit according to the present invention.

FIG. 3 is a side view of the feed supply unit according to the present invention.

FIG. 4 is a perspective view of a pellet supply unit according to the present invention.

FIG. 5 is an exploded perspective view of the pellet supply unit according to the present invention.

FIG. 6 is a side view of the pellet supply unit according to the present invention.

FIG. 7 is a perspective view of a main body constituting the pellet supply unit according to the present invention.

FIG. 8 is a perspective view illustrating a state in which a feed storage part is coupled to the feed supply unit according to the present invention.

FIG. 9 is a front view of a pusher part constituting the pellet supply unit according to the present invention.

FIG. 10 is a front view a pusher part constituting the pellet supply unit according to another embodiment of the present invention.

FIG. 10 is a front view a pusher part constituting the pellet supply unit according to further another embodiment of the present invention.

FIG. 12 is a perspective view of a rotation plate constituting the pellet supply unit according to the present invention.

FIG. 13 is a perspective view of a feed throwing unit at a seating position according to the present invention.

FIG. 14 is a perspective view of the feed throwing unit at a throwing position according to the present invention.

FIG. 15 is a side view of the feed throwing unit at the seating position according to the present invention.

FIG. 16 is a side view of the feed throwing unit at the throwing position according to the present invention.

FIG. 17 is a perspective view of an elastic driving part constituting the feed throwing unit according to the present invention.

FIG. 18 is a schematic view of the feed throwing unit at the seating position according to the present invention.

FIG. 19 is a schematic view illustrating a state in which an elastic member is tensioned from the state of FIG. 18.

FIG. 20 is a schematic view illustrating a state in which a hook member is separated from the state of FIG. 18 to allow a throw part to rotate to the throwing position.

FIG. 21 is a perspective view of a hook part at the seating position of the throw part according to the present invention.

FIG. 22 is a perspective view of the hook part at the throwing position of the throw part according to the present invention.

FIG. 23 is a perspective view of a feed powder accommodation part according to the present invention.

FIG. 24 is a perspective view of a separation prevention plate according to the present invention.

FIG. 25 is a side view of the rotary apparatus for throwing the feed at the seating position according to the present invention.

FIG. 26 is a graph illustrating a predicted reach position of the feed and a predicted cumulative moving distance of a pet according to the present invention.

FIG. 27 is a graph illustrating a feed throwing path according to the present invention.

### DESCRIPTION OF THE CODE ON THE MAIN PART OF THE DRAWING

100: Pellet supply unit
110: Body part
120: Rotation plate part
130: Rotation plate driving part
140: Detection sensor
200: Apparatus for throwing feed
210: Throw part
220: Rotation support part
230: Elastic driving part
240: Hook part
250: Stopper
260: Feed powder accommodation part
300: Rotation driving unit
310: Base driving part
320: Base tilting part
400: Control unit
410: Sight line generation part
420: Reach position calculation part
430: Moving distance calculation part
440: Database part
450: Consumed calorie calculation part
500: Camera unit
600: Communication unit
700: Display unit
710: Input unit
1: User terminal
10: Case part
30: Guide part
40: Separation prevention plate

### MODE FOR CARRYING OUT THE INVENTION

Hereinafter, embodiments of the present invention will be described with reference to the accompanying drawings. A rotary apparatus for throwing a feed according to the present invention throws a feed having the form of a pellet to a pet while rotating. Thus, the pet may chew the feeds one by one to help digestion thereof and feel the fun and eat the feed, the feed may be regularly supplied even when the user is absent, and the quantity of exercise of the pet may be measured and improved.

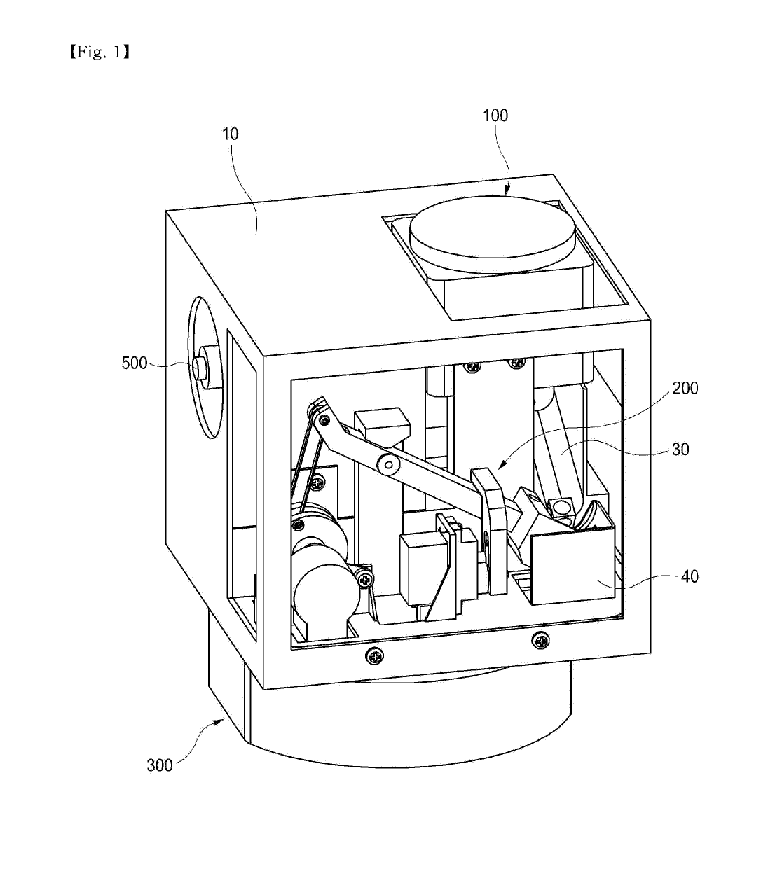

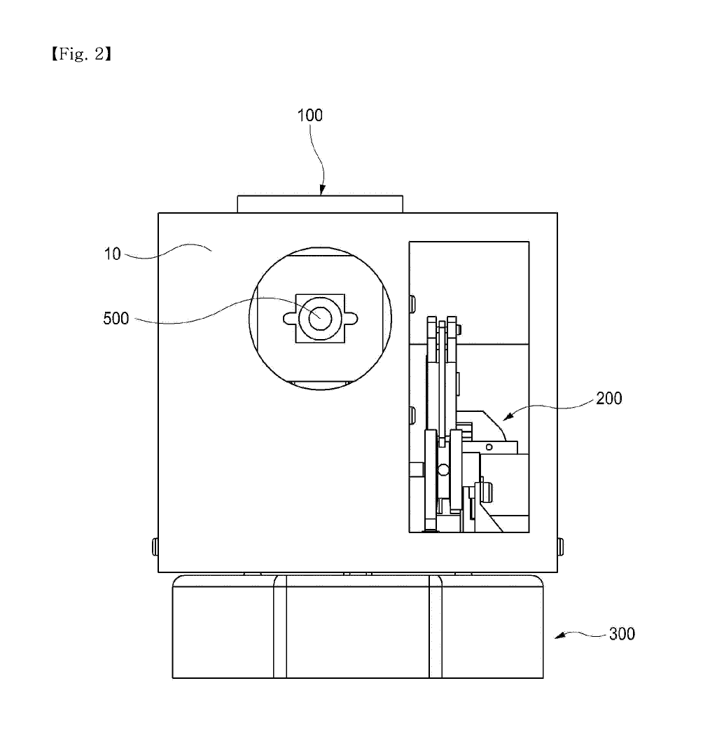

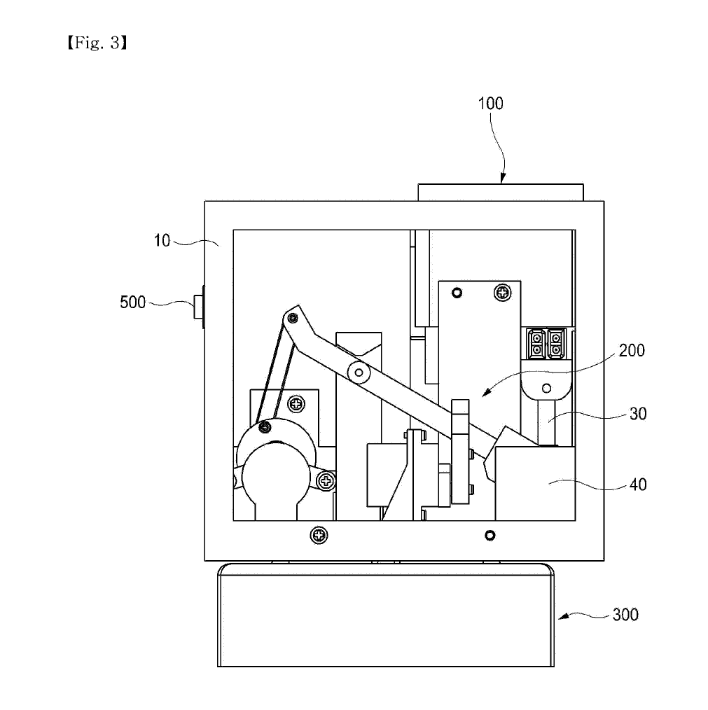

As illustrated in FIGS. 1 to 3, the rotary apparatus for throwing the feed includes a pellet supply unit 100, a feed throwing unit 200, a rotation driving unit 300, a camera unit 500, a communication unit 600, a control unit 400, and a display unit 700.

The pellet supply unit 100 discharges pellet feeds from an inner space 111 in which the pellet feeds for the pet are stored to supply the feeds.

The feed throwing unit 200 receives the set number of feeds from the pellet supply unit 100 to throw the feed in the air.

The rotation driving unit 300 rotates the feed throwing unit 200 to adjust a throwing direction of the feed.

The control unit 400 controls operations of the pellet supply unit 100, the feed throwing unit 200, and the rotation driving unit 300 according to an input signal.

The pellet supply unit 100, the feed throwing unit 200, the rotation driving unit 300, and the control unit 400, which constitute the rotary apparatus for throwing the feed according to the present invention, will be described in detail.

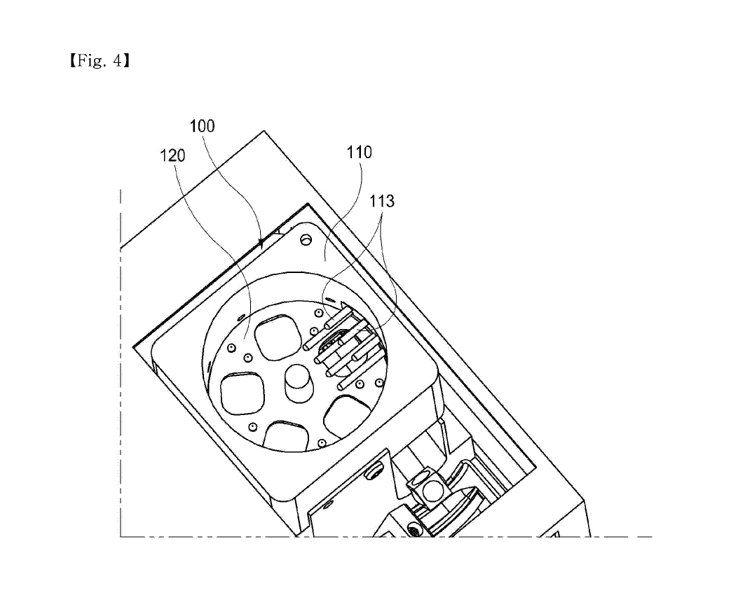

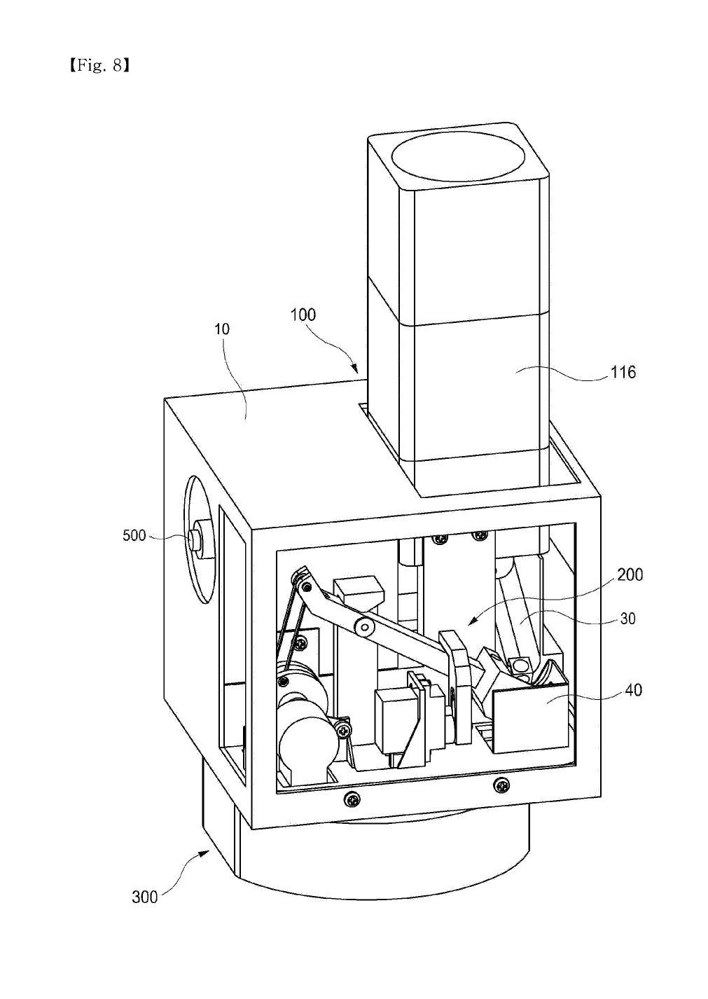

As illustrated in FIGS. 4 to 12, the pellet supply unit 100 includes a body part 110, a rotation plate part 120, a rotation plate driving part 130, and a detection sensor 140.

A body part 110 has a fixed hole 112, through which the feed is discharged, in a bottom surface of the inner space 111.

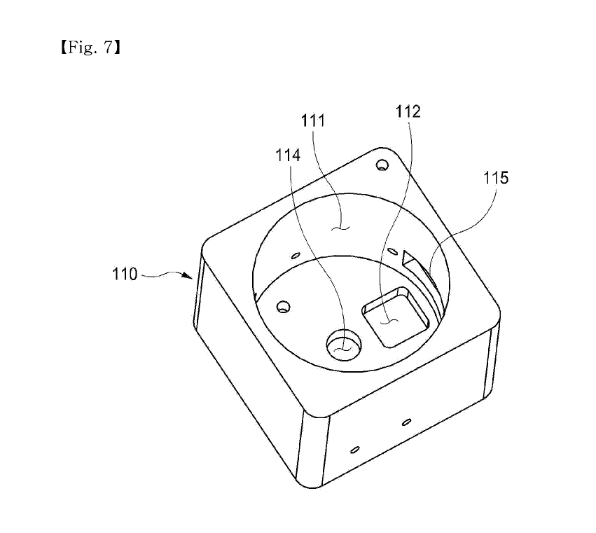

As illustrated in FIG. 7, the body part 110 is provided with an inner space 111 in which the pellet feeds are stored. A fixed hole 112, a rotation plate driving part insertion hole 114, and a pusher part arrangement plate insertion hole 115 are provided in the inner space 111.

The fixed hole 112 is formed in a position that is eccentric from a center of a bottom surface of the inner space 111 so that the feed is discharged from the inner space 111 to the outside of the body part 110 through the fixed hole 112.

The rotation plate driving part insertion hole 114 is formed in the center of the bottom surface of the inner space 111 and connects the rotation plate driving part 140 disposed outside the body part 110 to the rotation plate part 120 disposed inside the body part 110 to transmit a rotation driving force.

The pusher part disposition plate insertion hole 115 is formed in a side surface of the inner space 111 in a direction in which the fixed hole 112 is formed from the center of the inner space 111, and a pusher part arrangement plate 113e that will be described below is inserted into the pusher part arrangement plate insertion hole 115 and then coupled to the body part 110.

The body part 110 may include a feed storage part 116 and a pusher part 113.

The feed storage part 116 is formed on an upper portion of the body part 110 to extend and coupled to an upper portion of the inner space 111 to expand a feed storage capacity. Thus, the feed storage part 116 may be additionally provided according to an amount of feed consumed by the pet to increase the feed storage capacity, or the feed storage part 116 may be removed to reduce a volume of the apparatus for supplying the feed. Here, the number of feed storage parts 116 may be adjusted to set a feed storage capacity.

The pusher part 113 is provided on an upper portion of the fixed hole 112. One feed is discharged through the fixed hole 112, and introduction of the rest of feeds to the discharge position is prevented. Here, the discharge position refers to a position at which the rotation hole 121 and the fixed hole 112, which are formed in the rotation plate part 120, meet each other, i.e., a position through which the feed seated in the rotation hole 121 is discharged through the fixed hole 112.

Particularly, the feed seated in the rotation hole 121 formed in the rotation plate part 120 is discharged to the outside of the body part 110 through the fixed hole 112 when the rotation plate part 120 rotates to reach the discharge position. Here, the pusher part 113 introduces only one feed seated in the rotation hole 121 to the discharge position and blocks the introduction of the rest of feeds. Thus, the feeds may be provided in the form of the pellets.

The pusher part 113 is made of an elastic material, for example, made of a soft silicon material. Thus, the pusher part 113 may flexibly contact the feeds while blocking the rest of feeds to prevent the feeds from being introduced into the discharge position without damaging the feeds.

The pusher part 113 may be disposed in various shapes. A height from the bottom surface of the inner space 111 to a lower end of the pusher part 113 is greater than a maximum width of the feed and less than twice the maximum width of the feed. Thus, only one feed is introduced to the discharge position, and the rest of feeds are caught by the pusher part and thus blocked in introduction.

First, the pusher part 113 basically includes a pusher part arrangement plate 113e. The introduction of the feeds is blocked by at least one of a lower pin, an upper pin, and a protrusion plate, which protrude from the pusher part arrangement plate 113e.

The pusher part arrangement plate 113e is inserted into and fixed to the pusher part arrangement plate insertion hole 115 of the body part 110. Although not shown, the pusher part arrangement plate 113e may not be separately provided but be formed to allow at least one of the lower pin, the upper pie, and the protrusion plate to protrude from an inner surface of the body part 110.

Two or more lower pins 113a are disposed. Here, the lower pins 113a are disposed in lateral directions, respectively.

The upper pins may be disposed to be spaced apart from each other above the lower pin 113a and divided into first and second upper pins 113b and 113c.

The first upper pin 113b is disposed vertically above at least one of the lower pins 113a, and the second upper pin 113c is disposed between the two lower pins 113c adjacent to each other.

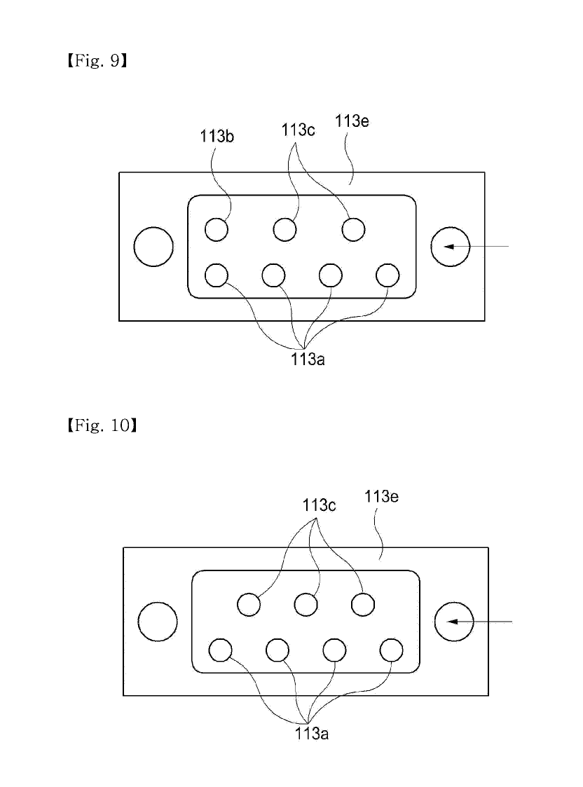

Hereinafter, the pusher part disposed in three shapes will be described in detail with reference to FIGS. 9 to 11. Here, an arrow expressed in the drawings represents a moving direction of the feeds due to the rotation of the rotation plate part 120.

First, as illustrated in FIG. 9, the pusher part 113 includes the first upper pin 113b and the second upper pin 113c.

Four lower pins 113a are disposed in lateral directions, respectively. A distance between the adjacent two lower pins 113a is less than a minimum width of the feed. Thus, the rest of feeds, which are blocked in introduction into the discharge position, may move to the upper portion of the pusher part 113 to prevent the feeds from being introduced into the discharge position by falling between the lower pins 113a.

The first upper pin 113b is disposed vertically above the lower pin 113a that is disposed at a first left side in the drawing. Here, the first upper pin 113b is disposed so that a distance between the upper pin 113b and the lower pin 113a that is disposed at the first position is less than the minimum width of the feed. Thus, the feeds, which are blocked in introduction into the discharge position, may move to the upper portion of the pusher part 113 to prevent the feeds from being introduced into the discharge position by falling between the lower pins 113a.

The first upper pin 113b may be disposed vertically above any lower pin 113a.

The second upper pins 113c may be disposed between the lower pins 113a that are disposed at second and third positions and between the lower pins 113a that are disposed at third and fourth positions in the drawing.

Second, as illustrated in FIG. 10, the pusher part 113 includes a lower pin 113a having a pin shape and a second upper pin 113c.

Four lower pins 113a are disposed in lateral directions, respectively.

Total three second upper pins 113c are spaced upward from the lower pins 113a and are disposed one by one between the adjacent two lower pins 113a. The second upper pins 113c are disposed so that a distance between the second upper pin 113c and at least one of the adjacent two lower pins 113a is less than the minimum width of the feed. Thus, the feeds, which are blocked in introduction into the discharge position, may move to the upper portion of the pusher part 113 to prevent the feeds from being introduced into the discharge position by falling between the second upper pin 113c and the adjacent lower pins 113a.

Here, a distance between the adjacent two second upper pins 113c is less than the minimum width of the feed.

Third, as illustrated in FIG. 11, the pusher part 113 includes a lower pin 113a having a pin shape, a second upper pin 113c, and a protrusion plate 113d.

Three lower pins 113a are disposed in lateral directions, respectively.

The second upper pins 113c are spaced upward from the lower pins 113a, and total two second upper pins 113c are disposed one by one between the adjacent two lower pins 113a.

The second upper pins 113c are disposed so that a distance between the second upper pin 113c and at least one of the adjacent two lower pins 113a is less than the minimum width of the feed. Thus, the feeds, which are blocked in introduction into the discharge position, may move to the upper portion of the pusher part 113 to prevent the feeds from being introduced into the discharge position by falling between the second upper pin 113c and the adjacent lower pins 113a.

The protrusion plate 113d is formed in the form of a plate, and a top surface of the protrusion plate 113d is disposed to be inclined upward in a direction in which the feed rotates. Thus, the rest of feeds, which are blocked in introduction into the discharge position, may easily move to the upper portion of the pusher part 113 to prevent the feeds from being introduced into the discharge position.

The pusher part 113 having the above-described three shapes may be disposed irrespective of the number of the lower pin, the first upper pin, the second upper pin, and the protrusion plate. Also, the pusher part 113 may be disposed in any shape as long as the rest of feeds is prevented from being introduced into the discharge position by falling through the pusher part 113, the pusher part 113.

When the upper pin (the first upper pin or the second upper pin) is provided in plurality, a distance between the adjacent two upper pins is less than the minimum width of the feed. This is done for preventing the rest of feeds from being jammed and stagnated between the two upper pins while the feeds move to the upper portion of the pusher part.

The rotation plate part 120 has one or more rotation holes 121 that relatively rotate with respect to the bottom surface of the body part 110. While the rotation holes 121 relatively rotate with respect to the body part 110, the pellet feed is discharged from a position at which the rotation holes 121 and the fixed hole 112 meet each other. Here, the rotation plate part 120 may be disposed above and below the bottom surface of the body part 110.

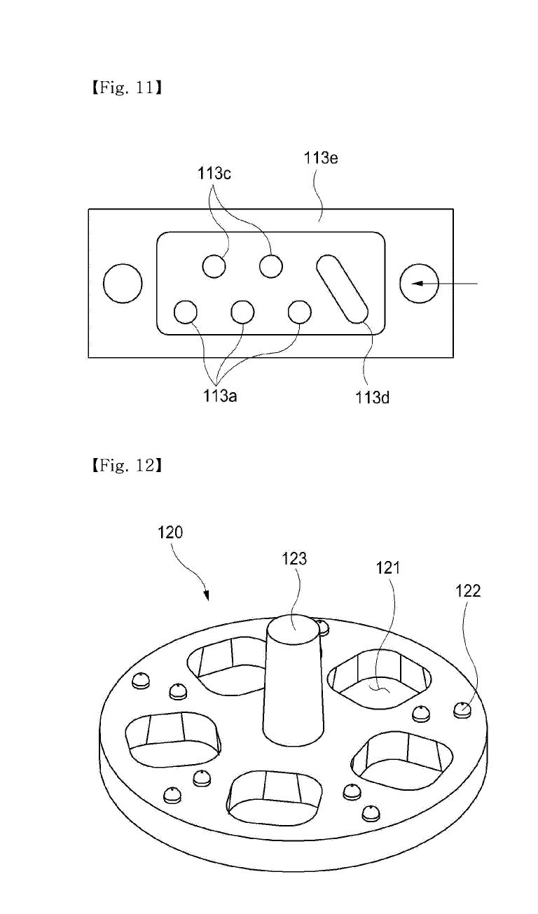

As illustrated in FIG. 12, the rotation plate part 120 is disposed in a lower portion of the inner space 111 to rotate and constituted by a rotation hole 121, a protrusion 122, and a central protrusion part 123.

The rotation hole 121 vertically passes through the rotation plate part 120, and one or more rotation holes 121 are formed. When the rotation plate part 120 rotates, the rotation hole 121 meets the fixed hole 112 to allow the feeds to be seated and move so that the feeds in the rotation hole 121 are discharged through the fixed hole 112.

The protrusion 122 protrudes from a top surface of the rotation plate 120. When the rotation plate part 120 rotates, the protrusion 122 stirs the feeds disposed on the upper portion of the rotation plate part 120 in the inner space 111. This is done for allowing the feeds to smoothly move in a vertical direction to prevent only the rotation plate part 120 from rotating due to the stagnation of the feeds in the inner space 111.

The central protrusion 123 protrudes from a rotational center of the top surface of the rotation plate 120. Thus, the feeds may be disposed to be eccentric from the center of the rotation plate part 120 so as to be rotatably movable. As a result, when the rotation plate part 120 rotates, the problem in which the feeds are disposed at the center of the rotation plate part 120 to rotate without movement may be prevented.

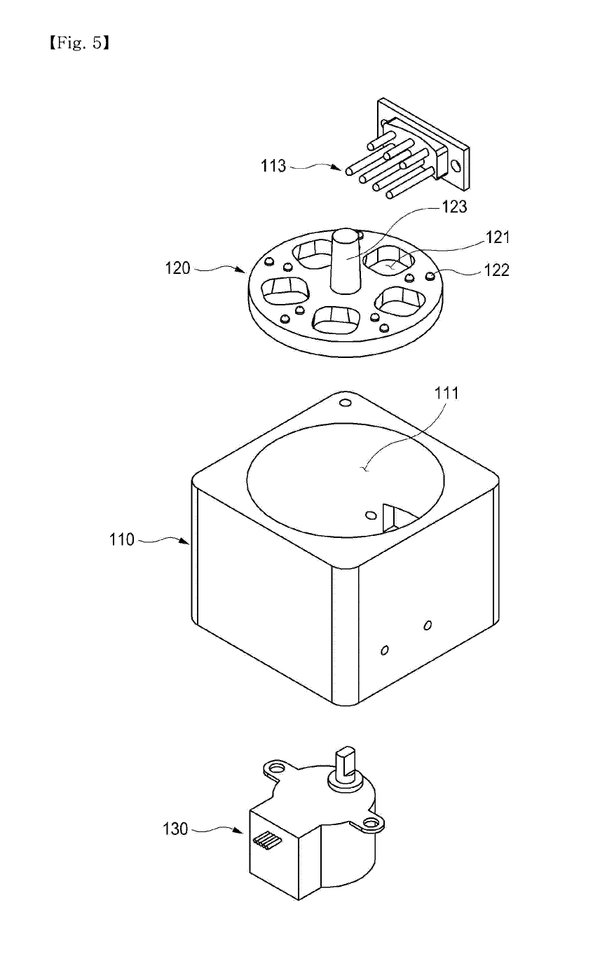

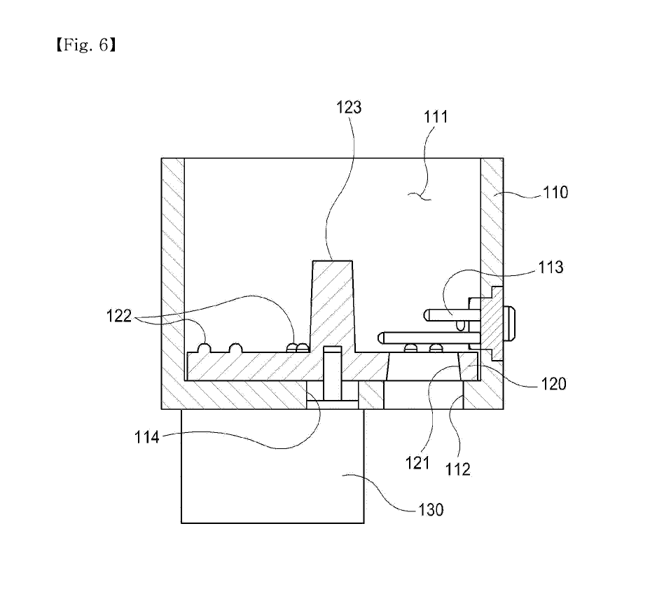

As illustrated in FIGS. 5 and 6, the rotation plate driving part 130 may be a driving member for rotating the rotation plate part 120. The rotation plate driving part 130 generates a rotational driving force and is connected to the rotation plate part 120 through the rotation plate driving part insertion hole 114. The rotation plate driving part 130 generates the rotational driving force to transmit the rotational driving force to the rotation plate part 120, thereby rotating the rotation plate part 120.

The detection sensor 140 is disposed in the fixed hole 112 to detect the feeds passing through the fixed hole 112. Thus, it is possible to grasp a problem such that the feeds are not supplied through the fixed hole 112, or a plurality of feeds are supplied.

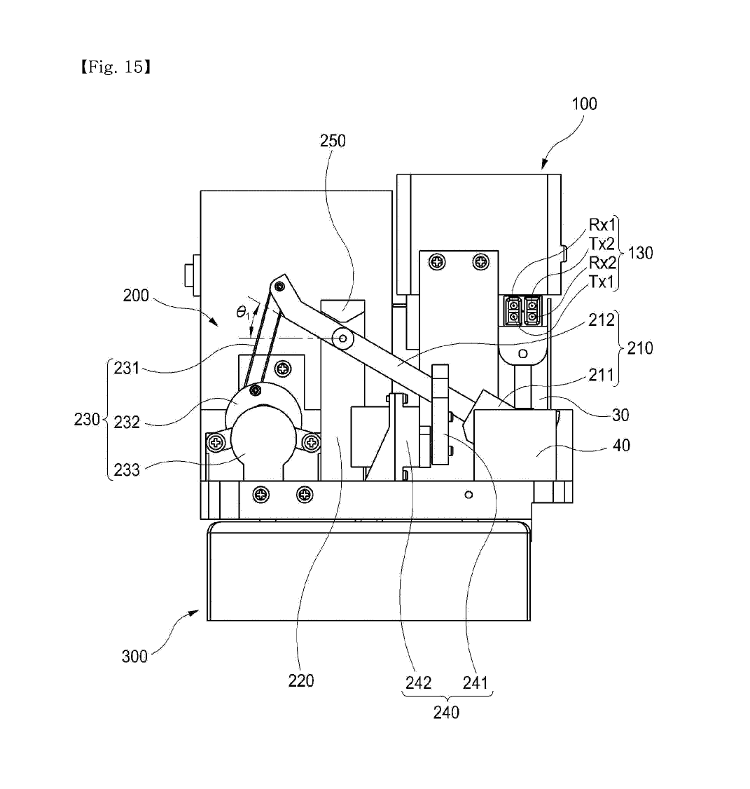

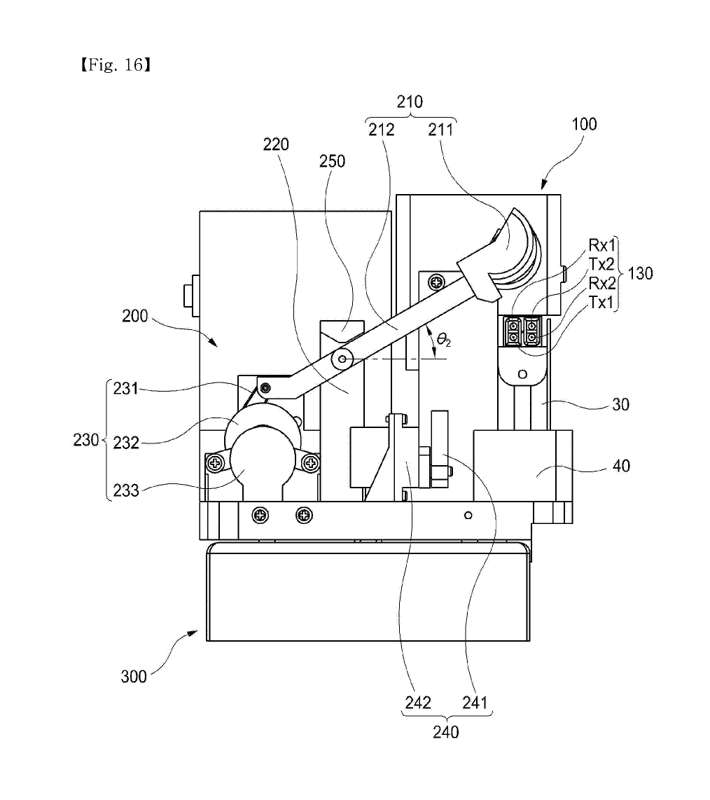

As illustrated in FIGS. 15 and 16, the detection sensor 140 may be constituted by a first light emitting part TX1, a first light receiving part RX1, a second light emitting part TX2, and a second light receiving part RX2.

The first light emitting part TX1 and the first light receiving part RX1 are vertically disposed in a pair. Light emitted from the first light emitting part TX1 may be reflected by the feeds and then received into the first light receiving part RX1 to detect whether the feeds are discharged.

The second light emitting part TX2 and the second light receiving part RX2 are vertically disposed in a pair. Light emitted from the second light emitting part TX2 may be reflected by the feeds and then received into the second light receiving part RX2 to detect whether the feeds are discharged.

Here, the second light emitting part TX2 and the second light receiving part RX2 may be disposed at side portions of the first light emitting part TX1 and the first light receiving part RX1. Thus, when compared that a pair of light emitting part and light receiving part are provided, the detection sensor may be improved in efficiency. Also, the first light emitting part TX1 may be disposed below the first light receiving part RX1, the second light emitting part TX2 may be disposed at the side portion of the first light receiving part RX1, and the second light receiving part RX2 may be disposed below the second light emitting part TX2. As described above, the light emitting part and the light receiving part are alternately disposed to more improve the efficiency of the sensor.

The control unit 400 controls an operation of the rotation plate driving part 130 according to whether the feeds are detected. Particularly, the control unit 400 receives information with respect to whether the feeds are detected from the detection sensor 140. When the detection sensor 140 detects the feeds, the operation of the rotation plate driving part 130 is stopped to step the rotation of the rotation plate part 120. Thus, the pellet feed may be supplied through the fixed hole 112, and a sufficient time may be secured for supplying the next feed. Since the sufficient time is secured, it is possible to consider the time taken to throw the pellet feed by the feed throwing unit 200. In addition, the pet may sufficiently chew the feed to help the digestion.

Also, the control unit 400 may control the rotation plate part 120 to continuously rotate when the rotation hole 121 reaches the discharge position, but the feed is not detected. Also, when the plurality of feeds pass through the fixed hole 112, the controller informs that the supply of the pellet feed is abnormal.

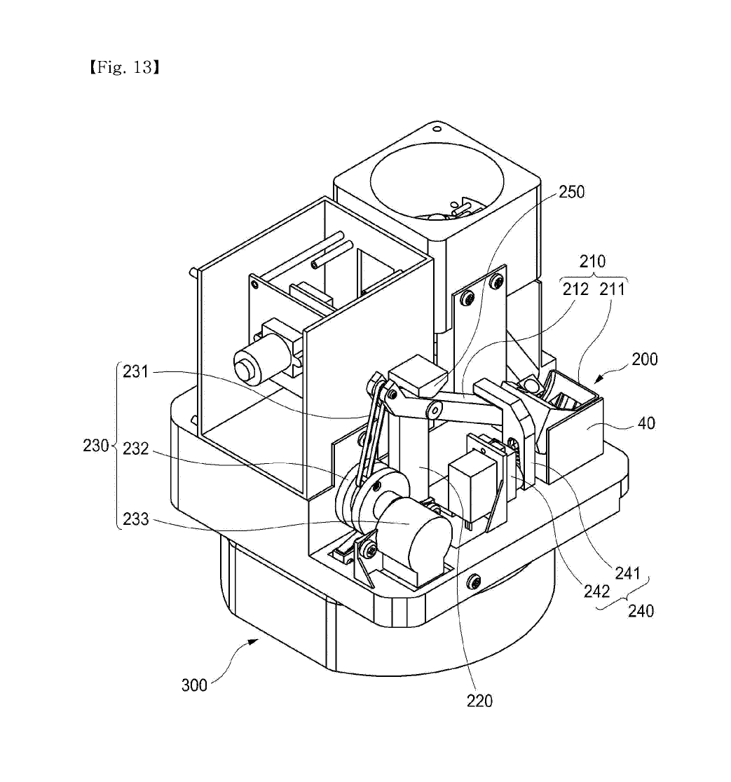

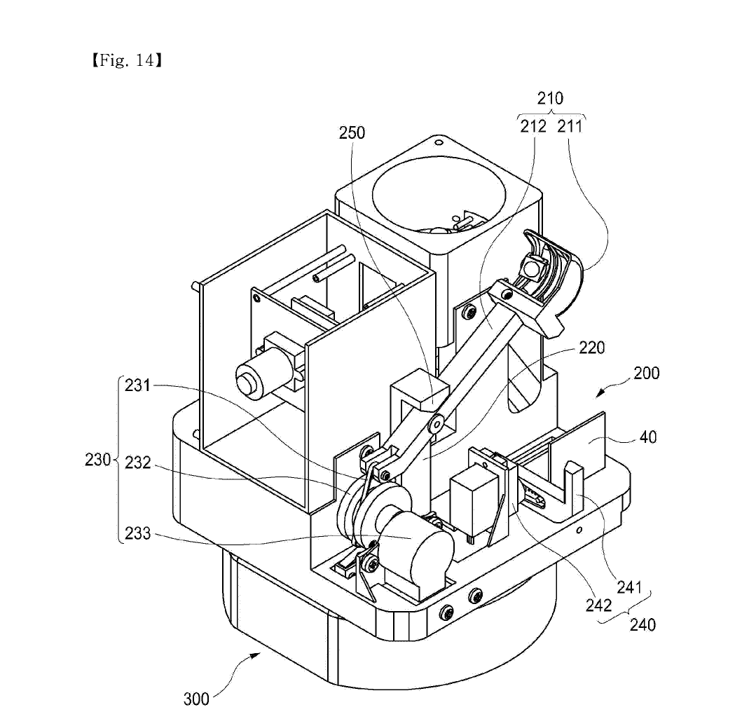

As illustrated in FIGS. 13 to 16, the feed throwing unit 200 is a unit for throwing the feeds discharged through the fixed hole 112 and includes a throw part 210, a rotation support part 220, an elastic driving part 230, a hook part 240, a stopper 250, and a feed powder accommodating part 260.

The throw part 210 includes a throw container 211 coupled to a throw arm 212 to seat the pellet feed thereon.

The throw part 210 throws the feeds supplied from the pellet supply unit 100 and includes a throw container 211 and a throw arm 212.

The throw container 211 has a recessed bowl shape to allow the pellet feed discharged through the fixed hole 112 of the pellet supply unit 100 to be seated.

Here, the throw container 211 serves as a point of action of the throw part 210. The throw arm 212 is a bar-shaped member coupled to the throw container 211 and rotates within a limited angle. Here, the throw part 210 rotates between a seating position and a throwing position to throw the feed seated on the throw container 211. Here, the ‘seating position’ is in a state in which the throw container 211 is disposed at a lower side to seat the feed, and the ‘throwing position’ is in a state in which the throw container 211 is disposed at an upper side to apply a force to the feed and thereby to throw the feed from the seating position.

The rotation support part 220 is coupled to the rotational center of the throw arm 212 to support the throw part 210. Thus, the throw part 210 may rotate with respect to the rotational center to throw the feed. Here, the rotational center serves as a support point of the throw part 210.

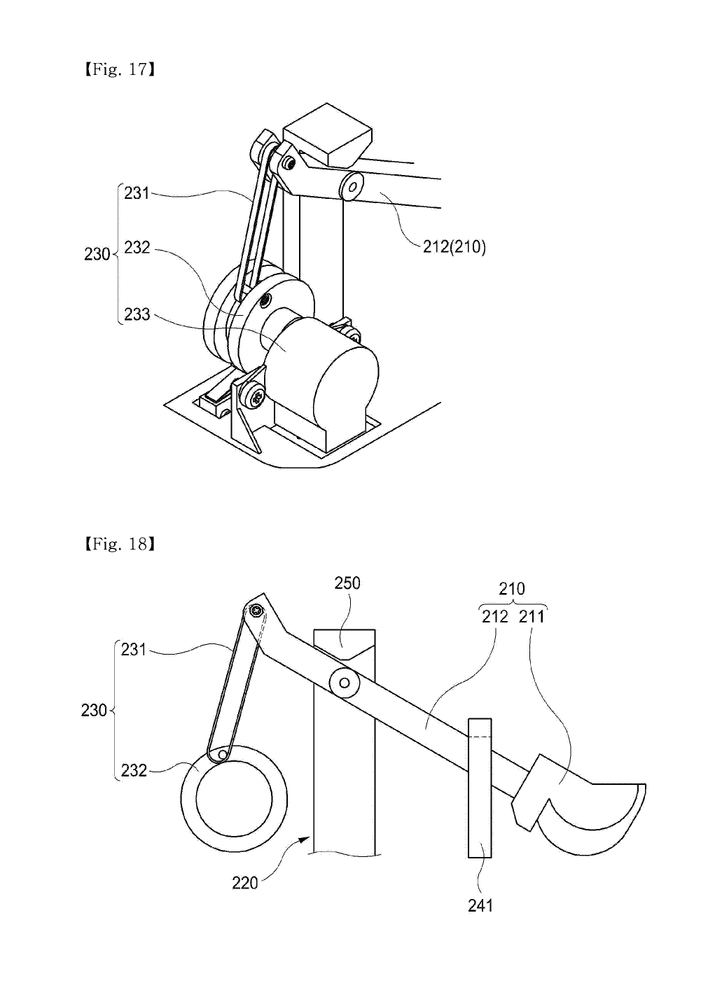

As illustrated in FIG. 17, the elastic driving part 230 rotates the throw container 211 between the seating position and the throwing position and includes an elastic member 231, a rotation drum 232, and a rotation driving source 233.

The elastic member 231 is made of an elastic material and thus tensioned to generate an elastic force. The elastic member 231 has one side connected to the throw arm 212 and the other side connected to the rotation drum 232. Here, a point at which the elastic member 231 and the throw arm 212 are connected to each other may be a force point of the throw part 210.

The rotation drum 232 is connected to the other side of the elastic member 231 to rotate. As the rotation drum 232 rotates, the elastic member 231 is wound around the outside of the rotation drum 232 and tensioned to generate an elastic force in the elastic member 231.

The rotation driving source 233 rotates the rotation drum 232 to provide the elastic force to the elastic member 231.

The control unit 400 may control the rotation driving source 233 to adjust a throwing distance by adjusting a rotation amount of rotation drum 232 of the elastic driving part 230.

The control unit 400 controls the rotation driving source 233 to adjust an rotation angle of the rotation drum 232 and adjusts an tensioned length of the elastic member 231 by changing the wound length of the elastic member 231 according to the rotation angle of the rotation drum 232. Thus, the elastic force generated in the elastic member 231 may be adjusted, and an intensity of the throwing of the feed may be adjusted to control the throwing distance of the feed.

Hereinafter, a process of driving the elastic driving part 230 will be described with reference to FIGS. 18 to 20.

FIG. 18 illustrates a state in which the throw part 210 is disposed at the seating position. The connected point of the throw arm 212 to which one side of the elastic member 231 is connected is disposed at an upper side, and the connected point of the rotation drum 232 to which the other side of the elastic member 231 is connected to is disposed to face the connected point of the throw arm 212. Here, the elastic member 231 is in a state in which the elastic member 231 is not tensioned and thus does not generate the elastic force.

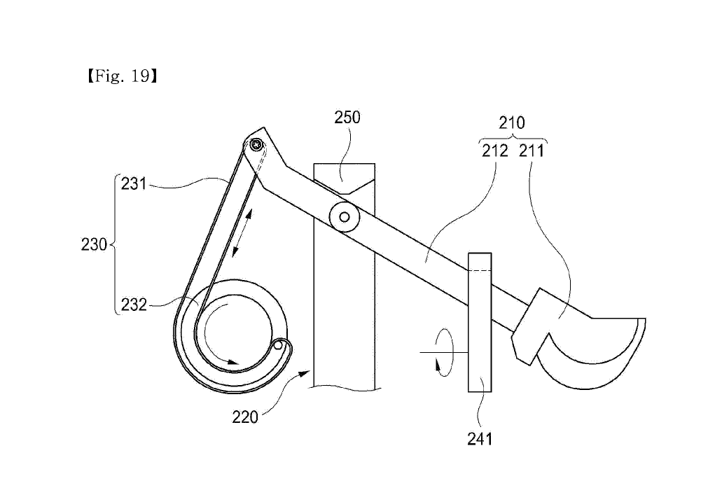

FIG. 19 illustrates a state in which the rotation drum 232 rotates to generate the rotation force. As the rotation drum 232 rotates, the connected point of the rotation drum 232 rotates to move in a counterclockwise direction in the drawing.

The throw arm 212 is in a state of being fixed at the seating position by the hook part 240. The connected point of the throw arm 212 is disposed at the upper side as ever, and the connected point of the rotation drum 232 rotates to move so that the other side of the elastic member 231 is wound around the outside of the rotation drum 232 and tensioned. Thus, the elastic member 231 generates the elastic force through the tension.

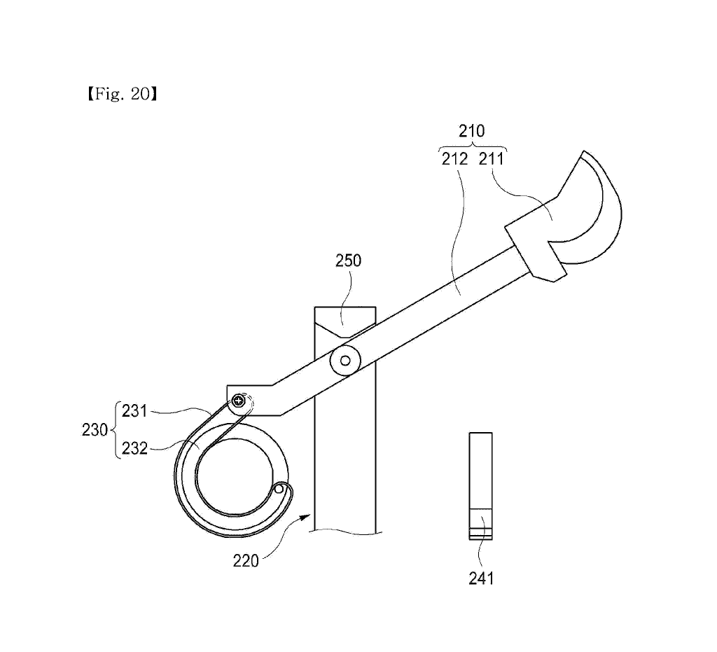

FIG. 20 illustrates a state in which the throw part 210 is disposed at the throwing position by the elastic force. The hook part 240 releases the state of the throw part 210, which is fixed to the seating position. Thus, the connected point of the throw arm 212 moves toward the rotation drum 232 by the elastic force and is disposed at the lower side, and the connected point of the rotation drum 232 is disposed at the same position. Thus, the elastic member 231 allows the throw part 210 to be disposed at the throwing position by the elastic force and thereby to consume the elastic force.

Thereafter, when the connected point of the rotation drum 232 rotates to move in a clockwise direction in the drawing, the throw part 210 is disposed at the seating position by a load as illustrated in FIG. 18. Here, the elastic force is not generated in the elastic member 231.

The elastic driving part may have any structure as long as the throw part is capable of rotating from the seating position to the throwing position by the elastic force.

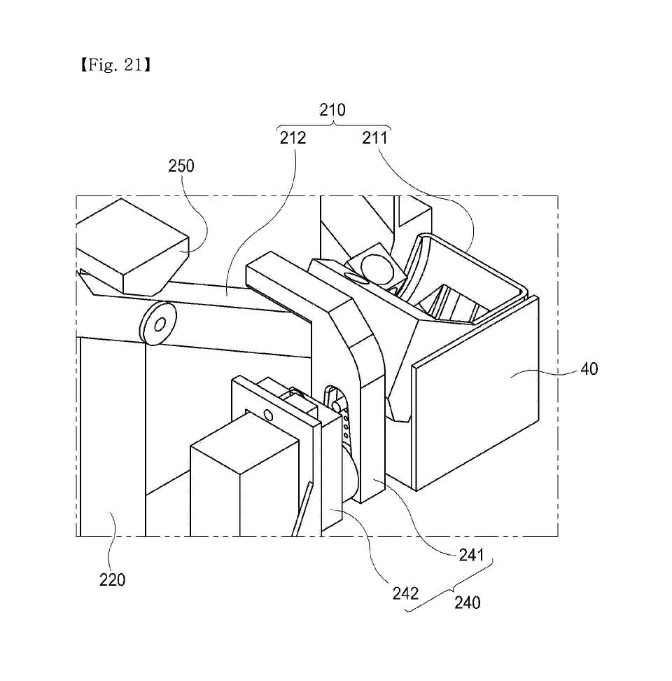

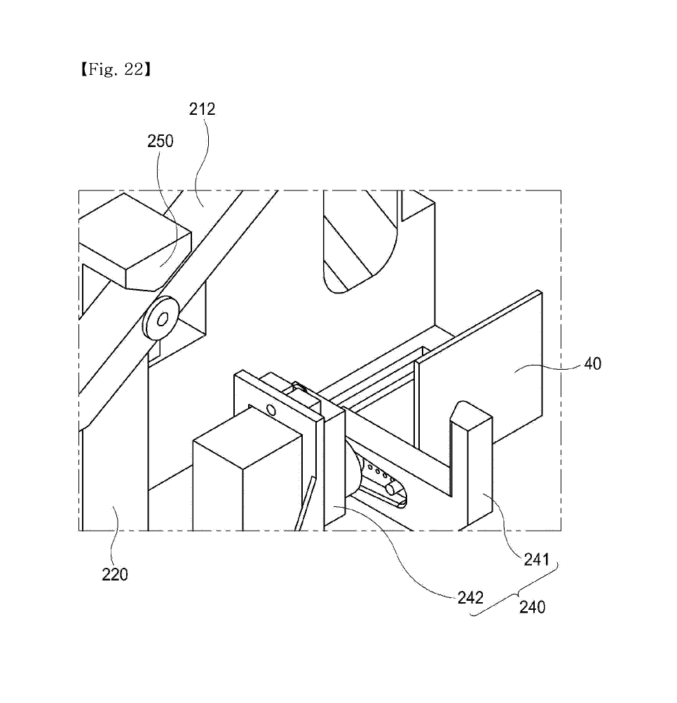

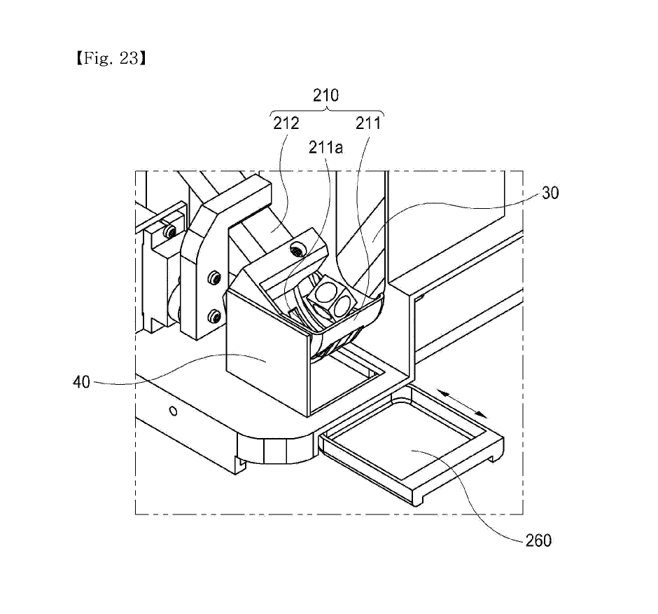

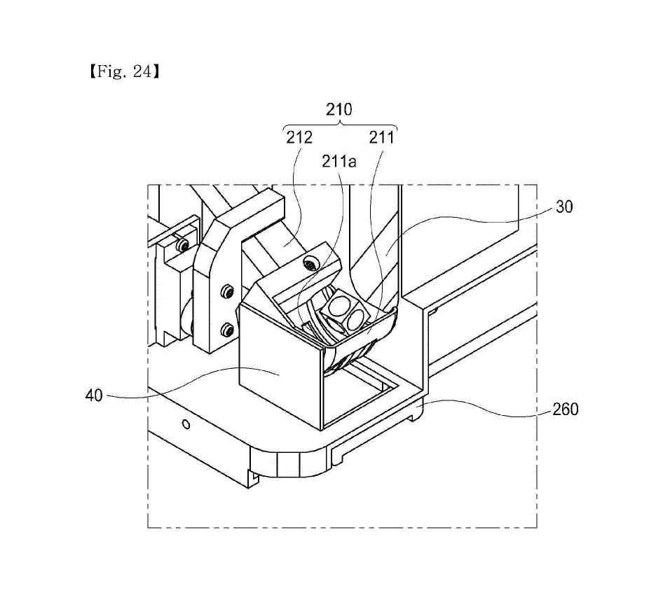

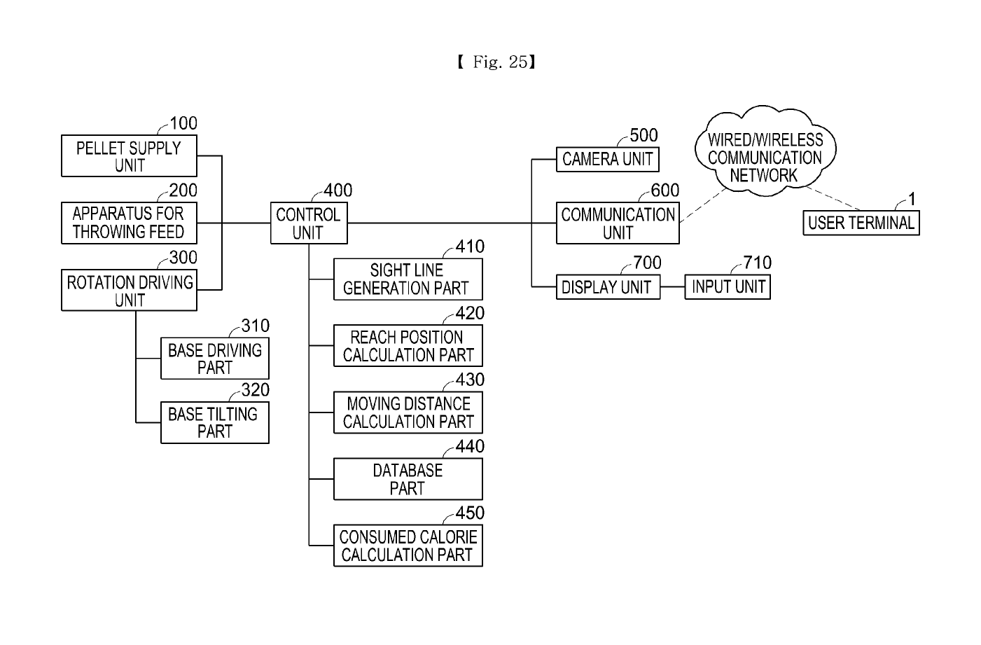

As illustrated in FIGS. 21 and 22, the hook part 240 is a support member that supports the seating position of the throw part 210 and includes a hook member 241 and a hook driving part 242.

The hook member 241 fixes the throw arm 212 at the seating position or releases the fixed state of the throw arm 212 so that the throw arm rotates from the seating position to the throwing position. Thus, in the state in which the elastic force is generated in the elastic member 231, the hook member 241 may fix the throw arm 212 so that the throw arm 212 is maintained at the seating position.

The hook driving part 242 moves between the position at which the throw arm 212 is fixed at the seating position and the position at which the fixed state of the throw part 212 is released to perform the locking and releasing functions.

Hereinafter, a process of driving the hook part 240 will be described with reference to FIGS. 21 and 22.

FIG. 21 illustrates a state in which the hook member 241 fixes the throw arm 212 at the seating position. The hook member 241 supports the throw arm 212, which is disposed between the rotational center and the throw container 211, from an upper side to maintain the seating position of the throw part 210. Thus, when the elastic force is generated toward the throwing position by the elastic driving part 230 at the seating position of the throw part 210, the throw arm is prevented from rotating to the throw position by the hook member 241.

FIG. 22 illustrates a state in which the hook member 241 releases the state in which the throw arm 212 is fixed to rotate from the seating position to the throwing position. The hook member 241 supporting an upper portion of the throw arm 212 rotates or moves. Thus, the supporting force of the hook member 241 with respect to the throw arm 212 may be released to allow the throw part 210 to rotate and move to the throwing position by the elastic force.

After the throw part 210 moves to the throwing position to throw the feed, the throw part 210 rotates and moves again to the seating position by the elastic driving part 230. In the state of moving to the seating position, the hook member 241 rotates or moves to an upper side of the throw arm 212 to maintain the seating position of the throw part 210.

The hook part 240 has a hook structure shape (for example, ‘¬’ shape) to rotate and move, thereby fixing the seating position of the throw arm 212 or releasing the fixed state of the throw arm 212. The hook part 240 may have any shape as long as the hook part 240 fixes the seating position of the throw arm 212 or releases the fixed state of the throw arm 212.

As illustrated in FIGS. 15 and 16, the stopper 250 limits the rotation angle of the throw arm 212 to set a seating position arrangement angle of the throw arm 212 and limits the rotation angle of the throw arm 212 at the throwing position to set the feed throwing angle.

The stopper 250 may be disposed above the rotation support part 220 and the throw part 210.

Particularly, referring to FIG. 15, the throw arm 212 is disposed at an inclined angle θ1 of 15° to 60° with respect to a horizontal plane at the seating position. When the inclined angle θ1 of the throw arm 212 is less than 15° at the seating position, an angle rotating to the throwing position is too small, and thus, it is difficult to generate a sufficient elastic force for throwing the feed. On the other hand, when the inclined angle θ1 of the throw arm 212 exceeds 60° at the seating position, the feed may not be seated on the throw container 211 to cause the falling.

Referring to FIG. 16, the throw arm 212 is disposed at an inclined angle θ2 of 15° to 60° with respect to the horizontal plane at the throwing position. Thus, the stopper 250 may set the feed throwing angle of the throw part 210. When the inclined angle θ2 of the throw arm 212 is less than 15° at the throwing position, an angle rotating to the throwing position is too small, and thus, it is difficult to generate a sufficient elastic force for throwing the feed. Also, the throwing angle of the feed is too large, and thus, the feed does not fly away and is thrown close to a vertical direction. On the other hand, when the inclined angle θ2 of the throw arm 212 exceeds 60° at the seating position, the throwing angle of the feed is too small, and thus, the feed is thrown close to a horizontal direction. Also, when the feed falls after being thrown, there is a problem that the feed is rolled from the falling point to enter into a lower side of furniture.

Thus, when the inclined angle θ2 of the throw arm 212 is set to 15° to 60°, more preferably, 20° to 50°, since the throwing angle of the feed is appropriate, a flying time of the feed is long, and the feed is not rolled when falling, and also, since the feed has a fly along a parabola, it is easy for the pet to catch the fly and eat the feed when the feed falls. The pet may also eat the flying feed before the feed falls.

Also, although not shown in the drawings, the stopper 250 may further include a stopper moving part.

The stopper moving part adjusts an arrangement position of the stopper so that the feed throwing angle is adjusted. Here, the arrangement angle of the throw arm may be adjusted by moving the position of the stopper to adjust the arrangement angle of the throw arm or by adjusting an inclined angle of a contact surface between the stopper and the throwing arm.

The stopper may have any shape as long as the arrangement angle of the throw arm is set at least one position of the seating position and the throwing position.

A pellet stopper may be provided to limit the arrangement angle of the throw arm at each of the seating position and the throw position.

The feed powder accommodation part 260 may accommodate feed powder generated from the feeds to easily clean the feed throwing unit. The throw container 211 has a discharge hole 211a in the bottom surface on which the feed is seated so that the powder generated while the feed is seated on the throw container 211 is discharged to the outside of the throw container 211 through the discharge hole 211a.

Thus, the throw container 211 may throw only the feed to neatly maintain the surrounding or inside of the feed throwing unit 200.

The feed powder accommodation part 260 is detachably disposed on a lower portion of the throw container 211 to accommodate the feed powder discharged from the discharge hole 211a of the throw container 211.

The feed powder accommodation part 260 may be slid in a drawer type and then detached from the feed throwing unit 200.

Thus, when the feed powder is accommodated into the feed powder accommodation part 260, the feed powder accommodation part 260 is separated to process the feed powder, and then, the feed powder accommodation part 260 is mounted again. Thus, the feed throwing unit 200 may be easily cleaned.

The rotation driving unit 300 is disposed below the feed throwing unit 200 to rotate the feed throwing unit 200 with respect to an axis perpendicular to the horizontal plane so that the throwing direction of the throw part 210 is adjusted. The rotation driving unit 300 may rotate the whole of the pellet supply unit 100 and the feed throwing unit 200 or pelletly rotate only the feed throwing unit 200.

Thus, the throwing direction of the feed may be adjusted. In addition, since the pet moves toward the feed that is thrown in various directions, a quantity of exercise of the pet may increase.

Also, the rotation driving unit 300 may tilt the feed throwing unit 200 with respect to the horizontal plane. Since the feed throwing angle varies, the throwing distance and the flying path of the feed may variously vary.

The rotation driving unit 300 may include a base, a base driving part 310, and a base tilting driving part 320.

The base is seated on the feed throwing unit 200.

The base driving part 310 drives the base to be rotatable with respect to a center of an axis perpendicular to a horizontal plane.

Thus, the throwing direction of the feed may be adjusted. The base tilting driving part 320 tilts the base. Here, the control unit 400 controls the tilted degree of the base tilting driving part 320 to adjust the throwing angle of the feed.

As illustrated in FIGS. 1 to 3, the pellet supply unit 100, the feed throwing unit 200, and the rotation driving unit 300 according to the present invention further include a case part 10, a guide part 30, a separation prevention part 40, and a sound source generation part.

The case part 10 is a member that covers the outsides of the pellet supply unit 100 and the feed throwing unit 200 to protect the units. An outer appearance of the rotary apparatus for supplying the feed may be elegant by the case part 10. Also, it is possible to prevent the pet or the user from interfering with the driving process of the feed throwing unit 200.

The case part 10 may have a hole or a switching part through which the feed is introduced into or discharged from the inner space 111 of the body part 110. Also, a hole through which the feed thrown from the feed throwing unit 200 is thrown to the outside of the case part 10 may be formed in the case part 10. Also, a side surface of the case part 10 provided with the feed throwing unit may be removed or provided as a transparent window so that the process of throwing the feed is visually inspected.

The guide part 30 guides the feed so that the feed discharged through the fixed hole 112 of the pellet supply unit 100 is seated on the throw container 211 of the feed throwing unit 200.

The guide part 30 is preferably formed to be inclined downward from the lower portion of the fixed hole 112 and may have various shapes such as a straight line shape and a curved shape.

Here, the guide part 30 is formed so that the guide part 30 does not interfere with a path along which the throw part 210 rotates between the seating position and the throwing position.

The separation prevention plate 40 is a member having a plate shape, which is disposed at a side portion of the throw container 211 and prevents the feed separated from the throw container 211 from being separated to the outside of the rotary apparatus for throwing the feed while the feed is supplied to the throw container 211 along the guide part 30.

The feed may be separated from the throw container 211 by the inclination of the guide part 30 and then be bounced to the side of the throw container 211. Here, the separation of the feed to the outside of the rotary apparatus for supplying the feed may be prevented by the separation prevention plate 40, and the feed colliding with the separation prevention plate 40 may fall into the feed powder accommodation part 260 disposed below the throw container 211 and then reused.

The sound source generation part generates a sound source before the feed seated on the throw container 211 is thrown. Thus, the pet may listen to the sound source generated from the sound source generation part prepare for taking the feed by predicting the throwing time of the feed.

Also, the sound source generation part may generate the sound source between the throwing time point of the feed and the falling time point of the feed to allow the pet to be aware of the flying time of the feed.

Thus, since the pet is aware of the feed supply period through the sound source generated from the sound source generation part, the user may train the pet.

In terms of the process of supplying the feed to the pet according to the rotary apparatus for supplying the feed, first, as the rotation plate part 120 of the pellet supply unit 100 rotates, the pellet feed is discharged through the fixed hole 112 at a point at which the feed seated in the rotation hole 121 meets the fixed hole 112.

The discharged feed is seated on the throw container 211 disposed at the seating position along the guide part 30. The elastic driving part 230 generates the elastic force by tensioning the elastic member 231 through the rotation of the rotation drum 232 in the throw part 210 is disposed at the seating position.

In the state in which the elastic member 231 generates the sufficient elastic force, and the feed is seated on the throw container 211, the hook member 241 rotates, and thus, the throw part 210 rotates to the throwing position by the elastic force.

The throw part 210 sets the throwing angle of the feed through the stopper 250.

After the feed is thrown, the elastic driving part 230 allows the rotation drum 232 to rotate in a reverse direction. Here, the elastic member 231 is not tensioned or contracted, and the throw part 210 rotates from the throwing position to the seating position.

When the throw part 210 is disposed at the seating position, the hook member 241 rotates again to fix the throw part 210 at the seating position and then waits for the next throw.

As described above, when the feed is supplied, the pet recognizes a route through which the feed is thrown to feel the fun and also reacts by a sound generated while the throw part is stopped at the throwing position by the stopper.

Also, the feed may be supplied in the form of the pellet to help the digestion of the pet by providing a sufficient time taken to chew and swallow the feed.

The feed throwing unit 200 may throw the set number, i.e., two or more feeds at the same time from the pellet supply unit 100. For example, when a plurality of pets are present, the feeds may be supplied from the pellet supply unit 100 until the feeds are seated on the throw container 211 by the same number as that of pets, and then, the plurality of feeds seated on the throw container 211 may be thrown at the same time. As a result, the plurality of feeds are thrown in directions different from each other so that the plurality of pets respectively eat the feeds without fighting each other.

The camera unit 500 obtains image information of the pet. As illustrated in FIGS. 1 to 3, the camera unit 500 may be mounted toward the direction in which the feed is thrown by the throw part 210. Thus, the camera unit 500 is driven to rotate together with the feed throwing unit 200 by the rotation driving unit 300 and thereby to obtain trace image information of the feed in the direction in which the feed is thrown.

Also, although not shown, the camera unit may obtain trace image information of the feed that is thrown at a fixed position spaced apart from the feed throwing unit. Here, the camera unit is connected to the control unit in a wired or wireless manner.

The camera unit 500 may be provided with a wide-angle lens to obtain image information of a wider space.

The communication unit 600 transmits the image information obtained by the camera unit 500 to the user terminal 1 and receives an input signal inputted into the user terminal in the wired or wireless manner. The input signal includes throwing information such as a throwing intensity, a throwing angle θ, a throwing azimuth φ, a throwing start signal, and the like.

That is, the communication unit 600 transmits and receives the information to/from the user terminal 1 through a wired/wireless communication network.

Thus, even when the user is outgoing or in a space different from that of the rotary apparatus for throwing the feed, the user may confirm where the food is thrown and how the pet feeds the thrown feed. Furthermore, the user terminal held by the user and the rotary apparatus for throwing the feed may be interlocked with each other to adjust the throwing intensity, the throwing angle θ, and the throwing azimuth φ due to the rotation of the rotation driving unit 300 according to instructs of the user through the user terminal or adjust a time till the next feed throwing after the feed is thrown, thereby supplying the feed to the pet.

The control unit 400 controls operations of the pellet supply unit 100, the feed throwing unit 200, and the rotation driving unit 300 according to an input signal.

The control unit 400 controls the rotation plate driving part 130, the elastic driving part 233, and the hook driving part 242 through the input signal received from the user terminal 1. Thus, the user may determine the throwing intensity, the throwing angle θ, the throwing azimuth φ, and the throwing time through the user terminal 1.

Since the user supplies the pets just as if the user directly throws the feed to the pet, the user may feel the connection with the pet even in the absence of the user or when the user is remotely located. Also, the pet may eat the feed, which is supplied from the rotary apparatus for throwing the feed, with fun through play to deteriorate psychological anxiety felt due to fear of being away from the user.

The control unit 400 includes a sight line generation part 410, a reach position calculation part 420, a moving distance calculation part 430, a database part 440, and a consumed calorie calculation part 450.

The sight line generation part 410 combines sight line information, which displays the throwing direction of the feed by the feed throwing unit 200, with a display of the user terminal 1. Here, the communication unit 600 transmits the image information combined with the sight line information to the user terminal 1.

Thus, the user may confirm the direction in which the feed is thrown by the feed throwing unit 200 through the user terminal 1. Also, the user may predict the throwing direction of the feed so that the user adjusts the food to be thrown in a desired direction.

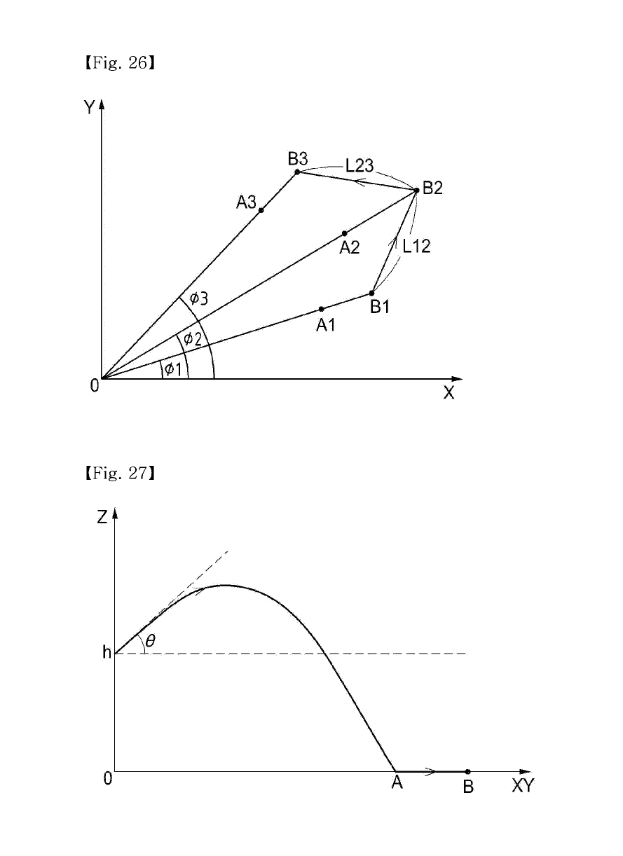

As illustrated in FIG. 26, the reach position calculation part 420 calculates predicted reach positions B1, B2, and B3 of the feed according to the throwing information.

FIG. 26 is a plan view of a throwing path of the feed thrown by the rotary apparatus for throwing the feed, and a point “O” represents a position of the rotary apparatus for throwing the feed.

A1 represents a position to which the first thrown feed falls, and B1 represents a predicted reach position that is calculated by predicting a final reach position of the feed in consideration of rolling of the first falling feed. Here, φ1 is a throwing azimuth of the first thrown feed.

Similarly, A2 represents a position to which the second thrown feed falls, B2 represents a predicted reach position of the second falling feed, and φ2 is a throwing azimuth of the second thrown feed.

A3 represents a position to which the third thrown feed falls, B3 represents a predicted reach position of the third falling feed, and φ3 is a throwing azimuth of the third thrown feed.

The reach position calculation part 420 calculates a predicted reach positions B1, B2, and B3 of the feed from the throwing intensity, the throwing angle θ, and the throwing azimuth φ.

The throwing information for calculating the predicted reach positions B1, B2, and B3 of the feed through the reach position calculation part 420 may further include a height h from the ground on which the feed throwing unit 200 is installed.

FIG. 27 is a side view of the throwing path of the feed that is thrown by the rotary apparatus for throwing the feed. Here, h represents a height from the ground on which the feed throwing unit 200 is installed, θ is the throwing intensity of the feed, A represents a falling position of the thrown feed, and B represents a predicted reach position that is calculated by predicting a final reach position of the feed in consideration of rolling of the falling feed.

When the installed position is high from the ground, since the predicted reach position of the feed is changed, it is necessary to consider the installation height h of the feed throwing unit 200 to the throwing information.

As illustrated in FIG. 26, the moving distance calculation part 430 cumulatively adds distances L12 and L23 between the predicted reach positions of the feeds that are sequentially thrown from the feed throwing unit 200 to calculate a predicted cumulative moving distance of the pet.

In FIG. 26, L12 represents a distance between the predicted reach position B1 of the first thrown feed and the predicted reach position B2 of the second thrown feed, and L23 represents a distance between the predicted reach position B2 of the second thrown feed and the predicted reach position B3 of the third thrown feed.

The predicted cumulative moving distance of the pet while the pet moves during a time from the first thrown feed to the second thrown feed by adding the distances L12 and L23 between the predicted reach positions of the sequentially thrown feeds because the pet moves the predicted reach position of the thrown feed to eat the feed.

The database part 440 stores consumed calorie information for each weight of the pets according to the moving distance. This is done because the calorie consumption varies defending on the weight of the pet even though the moving distance is the same.

Thus, the input further includes weight information of the pet that eat the feed.

The consumed calorie calculation part 450 calculates consumed calorie corresponding to the predicted cumulative moving distance according to the weight information inputted into the database part 440.

Thus, the calories consumed by the pet that eats the feed thrown from the rotary apparatus for throwing the feed may be calculated. Thus, the calorie obtained by providing the supplied feed to the pet and the consumed calorie may be compared with each other to adjust a supply amount of feed and a quantity of exercise of the pet. As a result, the user may manage the weight of the pet.

The control unit 400 controls the feed so that the feed is thrown according to the inputted throwing information. That is, the control unit 400 may control the throwing intensity, the throwing angle θ, and the throwing azimuth φ of the feed throwing unit 200, and also, a feed throwing time and a feed throwing number may be additionally provided.

The control unit 400 may control the rotary apparatus for throwing the feed in a random mode.

When the input signal inputted into the control unit 400 includes thrown feed number and random mode selection information, the control unit 400 is controlled in the random mode.

In the random mode, the control unit 400 may change at least one of the throwing intensity, the throwing angle θ, and the throwing azimuth φ of the feed throwing unit 200 according to the inputted random mode selection information to control the number of feeds so that the feeds are thrown to correspond to the inputted number of feed to be thrown.

Thus, even through the user does not input the throwing information of the feed every time, the feed throwing position may be changed to throw the feeds.

The display unit 700 includes an input unit 710 into which the input signal is inputted.

The control unit 400 displays the predicted cumulative moving distance on the display unit 700 whenever the feeds are sequentially thrown from the feed throwing unit 200.

The display unit 700 may display the throwing information, the image sight, the sight line information, the consumed calorie information, and the like as well as the predicted cumulative moving distance.

Although the specific embodiments of the present invention are described with reference to the accompanying drawings, it should be apparent that the scopes of the present invention affect equivalents and modifications within the technical spirit as set forth in the claims.

### INDUSTRIAL APPLICABILITY

The present invention provides the rotary apparatus for throwing the feed, which throws the feed having the form of the pellet to a pat.

1. A rotary apparatus for throwing a feed, the rotary apparatus comprising:
a pellet supply unit discharging a pellet feed from an inner space in which the pellet feeds for a pet are stored;
a feed throwing unit receiving the set number of feeds from the pellet supply unit to throw the feed in the air;
a rotation driving unit rotating the feed throwing unit to adjust a throwing direction of the feed; and
a control unit controlling operation of the pellet supply unit, the feed throwing unit, and the rotation driving unit according to an input signal.

2. The rotary apparatus of claim 1, wherein the pellet supply unit comprises:
a body part having a fixed hole, through which the feed is discharged, in a bottom of the inner space; and
a rotation plate part having one or more rotation holes that relatively rotate with respect to a bottom surface of the body part and rotating so that the pellet feed is discharged from a position at which each of the rotation holes and the fixed hole meet each other.

3. The rotary apparatus of claim 1, wherein the feed throwing unit comprises:
a throw part comprising a throw container coupled to a rotating throw arm to allow the pellet feed to be seated thereon;
a rotation support part coupled to a rotational center of the throw arm; and
an elastic driving part rotating the throw container between a seating position at which the feed is seated and a throwing position at which the feed is thrown.

4. The rotary apparatus of claim 1, wherein the rotation driving unit comprises:
a base on which the feed throwing unit is seated on an upper portion thereof; and
a base driving part rotatably driving the base with respect to an axis perpendicular to a horizontal plane.

5. The rotary apparatus of claim 4, wherein the rotation driving unit further comprises a base tilting driving part tilting the base, and
the control unit controls a tilted degree of the base tilting driving part to adjust a throwing angle of the feed.

6. The rotary apparatus of claim 1, further comprising:
a camera unit obtaining image information of the pet; and
a wired or wireless communication unit transmitting the image information to a user terminal and receiving the input signal inputted into the user terminal.

7. The rotary apparatus of claim 6, wherein the camera unit is driven to rotate together with the feed throwing unit by the rotation driving unit.

8. The rotary apparatus of claim 6, wherein the camera unit is connected to the control unit in a wired or wireless manner to obtain trace image information of the feed thrown at a fixed position spaced apart from the feed throwing unit.

9. The rotary apparatus of claim 8, wherein the control unit further comprises a sight line generation part that combines sight line information for displaying a throwing direction of the feed by the feed throwing unit on a display of the user terminal with the image information, and
the communication unit transmits the image information with which the sight line information is combined to the user terminal.

10. The rotary apparatus of claim 8, wherein the camera unit comprises a wide-angle lens.

11. The rotary apparatus of claim 1, wherein the input signal comprises throwing information constituted by a throwing intensity and a throwing angle (θ) of the feed throwing unit and a throwing azimuth (φ) due to the rotation of the rotation driving unit, and
the control unit comprises:
a reach position calculation part calculating a predicted reach position (B) of the feed according to the throwing information; and
a moving distance calculation part calculating a predicted cumulative moving distance of the pet by cumulatively adding distances (L) between the predicted reach positions of the feeds that are sequentially thrown from the feed throwing unit.

12. The rotary apparatus of claim 11, wherein the throwing information further comprises a height (h) from the ground on which the feed throwing unit is installed.

13. The rotary apparatus of claim 11, further comprising a display unit provided with an input unit into which the input signal is inputted,
wherein the control unit displays the predicted cumulative moving distance on the display unit whenever the feeds are sequentially thrown from the feed throwing unit.

14. The rotary apparatus of claim 11, further comprising a database part storing consumed calorie information for each weight of the pets according to the moving distance,
wherein the input signal further comprises weight information of the pet that eat the feed, and
the control unit further comprises a consumed calorie calculation part calculating consumed calorie corresponding to the predicted cumulative moving distance according to the weight information inputted into the database part.

15. The rotary apparatus of claim 1, wherein the input signal comprises throwing information constituted by a throwing angle (θ) of the feed throwing unit and a throwing azimuth (φ) due to the rotation of the rotation driving unit, and
the control unit controls the feed so that the feed is thrown according to the inputted throwing information.

16. The rotary apparatus of claim 1, wherein the input signal comprises thrown feed number and random mode selection information, and
the control unit changes at least one of a throwing intensity, a throwing angle (θ), and a throwing azimuth (φ) of the feed throwing unit according to the inputted random mode selection information to control the number of feeds so that the feeds are thrown to correspond to the inputted number of feed to be thrown.
